(19) United States
(12) Patent Application Publication
(10) Pub. No.: US 2026/0097243 A1
(43) Pub. Date: Apr. 9, 2026

(54) OPERABILITY INDICATOR DEVICE

(71) Applicant: SAFRAN AEROSYSTEMS, PLAISIR (FR)

(72) Inventor: Thomas BRAUNLICH, MOISSY CRAMAYEL (FR)

(73) Assignee: SAFRAN AEROSYSTEMS, PLAISIR (FR)

(21) Appl. No.: 19/404,453

(22) Filed: Dec. 1, 2025

Related U.S. Application Data
(63) Continuation of application No. PCT/FR2024/050695, filed on May 30, 2024.

(30) Foreign Application Priority Data
Jun. 2, 2023 (FR) 23/05564

(51) Int. Cl. A62B 9/00; A62B 18/08; A62B 25/00

(52) U.S. Cl. CPC A62B 9/006; A62B 18/08; A62B 25/00

(57) ABSTRACT

An operability indicator device to be fitted to a packaging box inside which there is a bag containing a vacuum-packed protective hood includes a viewing port and a flag member including a first visual operability indicator and a second visual inoperability indicator. The flag member is movable between a nominal position in which the first visual operability indicator is visible through the viewing port and a warning position in which the second visual inoperability indicator becomes visible through the viewing port and replaces the first visual operability indicator. The flag member includes a bearing face against which, upon the inflation of this bag inside the packaging box, the bag presses and causes the flag member to move from the nominal position to the warning position.

### CROSS-REFERENCE TO RELATED APPLICATIONS

This application is a continuation of International Application No. PCT/FR2024/050695, filed on May 30, 2024, which claims priority to and the benefit of French Patent Application No. 23/05564 filed on June 2, 2023. The disclosures of the above applications are incorporated herein by reference.

### FIELD

The present disclosure relates to an operability indicator device for safety equipment.

### BACKGROUND

The statements in this section merely provide background information related to the present disclosure and may not constitute prior art.

A hood comprising a flexible airtight envelope intended to be put on the head of a user is from patent application EP2979561, the flexible envelope being provided with a transparent window and comprising, in its lower part, a rigid base element of generally annular shape intended to be arranged around the neck of the user. The base element comprises a tubular oxygen reservoir provided with a calibrated outlet orifice opening into the internal volume of the flexible envelope. This type of device is used on board aircraft when the cabin atmosphere is contaminated (depressurization, smoke, chemical agent, etc.). This equipment must, in particular, enable flight crew to deal with the issue, provide assistance to passengers, and manage a potential evacuation of the plane. This equipment can be packaged in a bag, itself placed in a packaging box. This packaging must comply with regulatory standards.

### SUMMARY

This section provides a general summary of the disclosure and is not a comprehensive disclosure of its full scope or all of its features.

The present disclosure aims, in particular, to improve the safety of such packaging.

The present disclosure provides an operability indicator device configured to be fitted to a packaging box inside which a bag containing, under vacuum, a safety equipment, in particular a protective hood, is placed. This operability indicator device including: a viewing window, a flag member including a visual indicator of proper operation and a visual indicator of malfunction, this flag member being movable between a nominal position in which the visual indicator of proper operation is visible through the viewing window, and a warning position in which the visual indicator of malfunction becomes visible through the viewing window, replacing the visual indicator of proper operation, the flag member further comprising a bearing face against which, upon the inflation of this bag inside the packaging box, the bag bears, this bearing against the bearing face causes the flag member to move from the nominal position towards the warning position, a spring secured to the flag member and configured to exert an elastic restoring force opposing the passage of the flag member from the nominal position towards the warning position until sufficient force is exerted by the inflating bag on the bearing face of the flag member, causing the flag member to pass from the nominal position to the warning position, an element for retaining the flag member in the warning position when this warning position has been reached, so that the flag member remains in the warning position even if the force exerted on the bearing face of the flag member ceases or is reduced.

The operability indicator device according to the present disclosure offers several advantages as explained below.

First, the present disclosure makes it possible to visually verify whether the bag, for various reasons, has inflated abnormally, in particular until this bag perforates. Such inflation followed by perforation of the bag results in the equipment contained therein being rendered inoperative. The present disclosure thus makes it possible to reliably verify whether the safety equipment, in particular a protective hood, is operative or not. For example, flight crew must be able to verify, using the operability indicator device according to the present disclosure, whether the equipment is still maintained under vacuum in the bag. Maintaining the bag under vacuum means that the equipment can be used. Conversely, if the bag is no longer under vacuum, then the equipment must not be used. Thanks to the present disclosure, it is possible to view the operability indicator device placed on the packaging box. This operability indicator device makes visible through the viewing window either a visual indicator of proper operation or a visual indicator of malfunction.

If the bag inflates, it exerts a thrust on the flag member. If the thrust reaches a certain threshold, then the flag tilts into the warning position and the visual indicator of malfunction appears through the viewing window. The present disclosure is particularly advantageous in that, after the pressure of the bag on the flag member is released, this flag member is retained in the warning position thanks to the retaining element according to the present disclosure. The operability indicator device according to the present disclosure thus makes it possible to memorize a situation of excessive inflation followed by perforation of the bag, so that the user is informed that the equipment is inoperative and should not be used. This warning is maintained even if the pressure of the bag on the flag member is released or has disappeared. In the absence of such a retaining element according to the present disclosure, the flag member would return to its nominal position under the action of the spring, which would erase the information about an anomaly in the inflation of the bag. The present disclosure thus allows for reliable verification of the operating state of the safety equipment packaged in the vacuum bag.

It may be chosen to have a target for triggering the visual indicator of malfunction after an aircraft cabin-type depressurization threshold at an altitude above 50 kft ("kilofeet").

In one example of the present disclosure, the retaining element is part of the spring.

In one example of the present disclosure, the retaining element is formed by a locking portion of the spring configured to engage with a locking element on a flag holder of the operability indicator device. This flag holder is, for example, made of plastic material and is configured, for example, to be fastened to the box by clipping or other means.

In one example of the present disclosure, the locking portion of the spring is formed by a locking window configured to engage on the locking element on the flag holder.

In one example of the present disclosure, this locking element on the flag holder is formed by a protrusion or boss on the flag holder.

In one example of the present disclosure, the locking window on the spring is substantially rectangular.

Thus, when the flag member reaches the warning position, the spring has the locking window engaged on the locking boss of the flag holder so that, even when the pressure exerted on the flag member ceases, the interaction between the locking window of the spring and the locking boss on the flag holder inhibits the flag member from returning towards the nominal position.

Alternatively, the locking window on the spring can be replaced by a step formed on the spring leaf, the step being configured to engage under the locking relief or boss of the flag holder, so as to lock the spring leaf under this relief or boss of the flag holder. In this case, the spring leaf can be solid, without a locking window.

In one example of the present disclosure, the flag member is configured to pivot about an axis of rotation passing through the flag holder.

In one example of the present disclosure, the flag member includes a bearing tab that defines the bearing face against which the bag bears upon the inflation of the bag.

In one example of the present disclosure, the flag member includes a central portion fastened with the spring.

In one example of the present disclosure, this fastening is achieved using one or several rivets that retain the flag member and the spring together.

In one example of the present disclosure, the flag member includes an information tab including a first area corresponding to the visual indicator of proper operation and a second area corresponding to the visual indicator of malfunction.

In one example of the present disclosure, these first and second areas, in particular adjacent to each other, are formed on a flat face of the information tab.

In one example of the present disclosure, these first and second areas have different colors. These colors are chosen to allow the user to easily recognize proper operation or malfunction. For example, these colored areas are painted areas.

In one example of the present disclosure, the first area corresponding to the visual indicator of proper operation is green, and the second area corresponding to the visual indicator of malfunction is red.

Other visual information, different from or in addition to colors, may be used. For example, a drawing or letters may be used as flags.

In one example of the present disclosure, the flag member has a substantially U-shaped side profile, with the central portion and, at the ends of this central portion, the bearing tab and the information tab.

In one example of the present disclosure, the bearing tab has a greater length than the information tab.

When the flag member tilts about the axis of rotation, the information tab pivots so that, in the nominal position, the first area corresponding to the visual indicator of proper operation is visible through the viewing window. When the flag member has tilted into the warning position, the second area of the information tab of the flag member becomes visible in the viewing window.

In one example of the present disclosure, the flag member is made of a rigid material.

In one example of the present disclosure, the flag member may be made of metal or, alternatively, of plastic material, in particular polycarbonate.

In one example of the present disclosure, the central portion of the flag member has two lateral pins serving as joints for pivoting about the axis of rotation.

In one example of the present disclosure, the spring includes a stage for fastening the spring to the flag member.

In one example of the present disclosure, the rivet(s) pass through this fastening stage.

In one example of the present disclosure, the spring includes a bend between a portion of the spring forming a leaf and this fastening stage.

In one example of the present disclosure, the bend forms an angle of approximately 90°, namely a right angle, when the spring and the flag member are in the nominal position.

In one example of the present disclosure, the spring leaf includes the locking window.

In one example of the present disclosure, the locking window is formed at one end of the leaf opposite the bend that connects the leaf to the fastening stage.

In one example t of the present disclosure, the locking window on the leaf is formed above the contact point between the leaf and the locking relief on the flag holder, so that when the flag member tilts from the nominal position, a solid part of the leaf bears against the locking relief of the flag holder.

Thus, the spring folds around the bend due to the force exerted by the tilting flag member. The spring then bears, with its leaf, against the locking relief or boss of the flag holder until the warning position is reached. When the tilt reaches the warning position, the window engages in the locking relief or boss of the flag holder, and this retention inhibits the spring from returning the flag member towards the nominal position.

In one example of the present disclosure, the spring has a width of between 8 and 14 mm, in particular 12 mm.

In one example of the present disclosure, the flag holder of the operability indicator device comprises the viewing window provided with a transparent plate placed in front of the information tab of the flag member.

The present disclosure further relates to a protective hood packaging box including an operability indicator device as described above.

In one example of the present disclosure, the operability indicator device is placed in an opening in a wall of the packaging box, for example, an opening on an opening flap of the packaging box.

In one example of the present disclosure, the packaging box is made of metal and/or plastic material.

In one example of the present disclosure, the packaging box is configured to be arranged in a compartment on board an aircraft.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a hood according to an exemplary implementation of the present disclosure, in the folded state;

FIG. 2 is a schematic representation of the hood of FIG. 1, in the unfolded state;

FIG. 3 is a schematic representation of the hood of FIG. 1, with the user moving the articulated device apart in order to be able to put on the hood;

FIG. 4 is an isolated schematic representation of the articulated device of the hood of FIG. 1;

FIG. 5 is a schematic representation of the hood of FIG. 1, put on the user’s head;

FIG. 6 is a schematic representation of a member for triggering the timer of the hood in FIG. 1;

FIG. 7 is a schematic representation of the hood in FIG. 1, stored in a bag;

FIG. 8 shows a warning sequence associated with the timer of the hood in FIG. 1;

FIG. 9 is a schematic representation of a packaging box according to one example of the present disclosure, in which a bag containing, under vacuum, a protective hood, is placed;

FIG. 10 is a schematic representation of the operability indicator device configured to be fitted to the packaging box in FIG. 9;

FIG. 11 is a schematic cross-sectional representation of the operability indicator device of FIG. 10, in the nominal position;

FIG. 12 is a schematic cross-sectional representation of the operability indicator device of FIG. 10, in the warning position;

FIG. 13 is a schematic representation of the packaging box according to FIG. 1, with the inflated bag;

FIG. 14 is a schematic cross-sectional representation of an operability indicator device according to another example of the present disclosure, in the nominal position;

FIG. 15 is a schematic cross-sectional representation of the operability indicator device of FIG. 14, in the warning position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The features, variants, and different examples of the present disclosure may be combined with each other, in various combinations, provided that they are not incompatible or mutually exclusive. In particular, variants of the present disclosure may be conceived comprising only a selection of features described hereafter in isolation from the other features described, if this selection of features is sufficient to confer a technical advantage and/or to differentiate the present disclosure from the prior art.

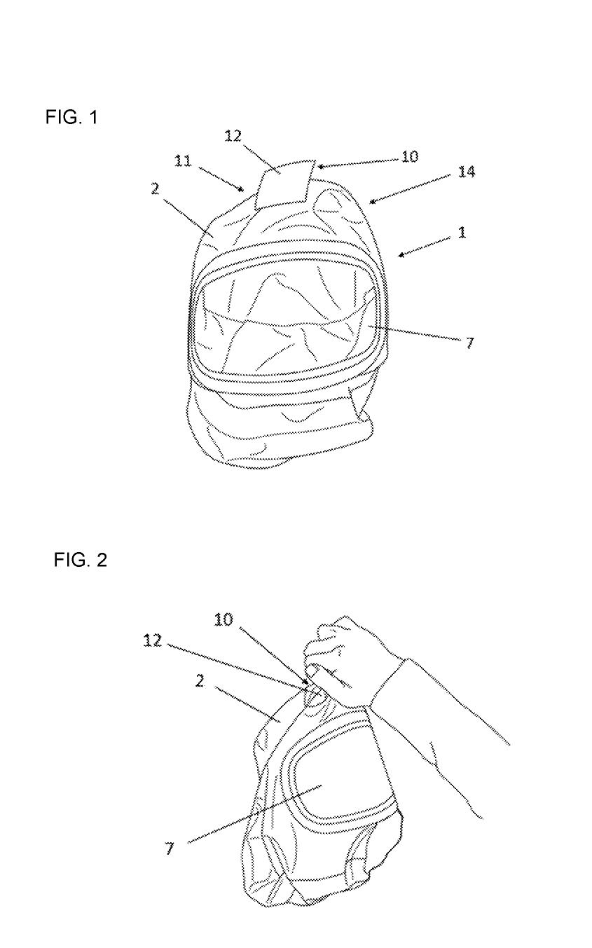

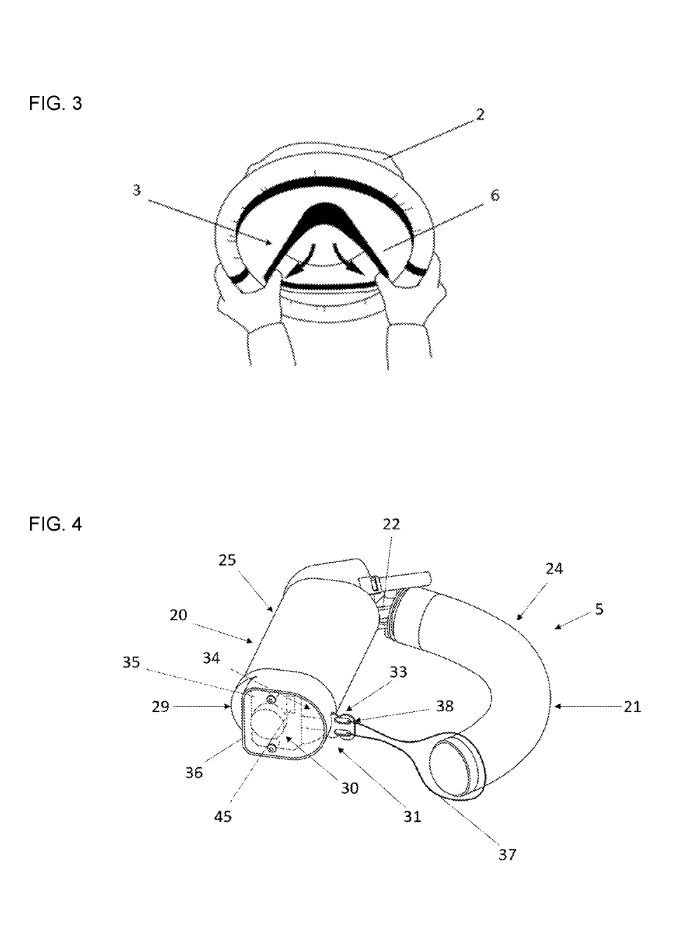

FIGS. 1 and 2 show a protective hood 1 including: a flexible envelope 2 configured to be stored in a folded state (state shown in FIG. 1) and to be put, in an unfolded state (state shown in FIG. 2), through an open base 3 of the flexible envelope 2, on the head of the user U, an articulated device 5 (shown separately in FIG. 4) secured to the open base 3 and configured to be placed around the neck of the user U when the flexible envelope 2 is put on the user’s head.

In the example described, the flexible envelope 2, which is airtight, mainly contains a Nomex® fabric and a flexible collar 6, in particular made of Neoprene®, forming the base 3.

The hood 1 also includes a semi-rigid visor 7, in particular made of transparent polymer, and optionally a sound-absorbing membrane (not shown).

The hood 1 further includes a handle 10 secured to the flexible envelope 2, this handle 10 being placed on a top 11 of the flexible envelope 2, in such a way accessible to the user when the flexible envelope 2 is in the folded state, as can be seen in FIG. 1.

In the example described, the handle 10 is in the form of a flexible strip 12, which is substantially rectangular in shape.

Other strip shapes may be provided, for example, a trapezoidal shape or a shape with a rounded portion.

The strip-shaped handle 10 is solid, namely it has no orifice. The handle 10 has no loop.

The strip-shaped handle 10 is fastened to the flexible envelope 2 by an edge of the strip, on an outer face 14 of this flexible envelope 2. For example, the handle 10 is heat-sealed to the flexible envelope 2.

The handle 10 is made of a self-extinguishing material, namely a material that can burn in a flame but extinguishes itself as soon as it is removed therefrom.

The handle 10 may or may not be made of the same material as the flexible envelope. The handle 10 could, if desired, be made as a single piece with the flexible envelope 2, for example, being an extension of the material of the flexible envelope.

Advantageously, the handle 10 has a color distinct from the color of the flexible envelope 2, in this case fluorescent yellow.

Thus, the handle 10 is easily and very quickly identifiable by the user when taking the folded hood 1 out of a bag. It may be desired for the equipment setup time to be less than 15 seconds.

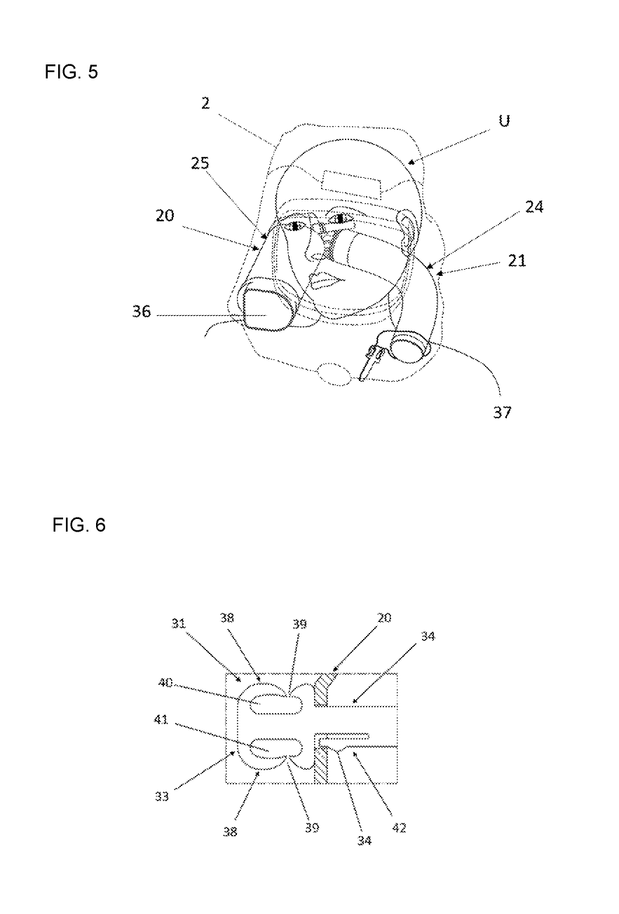

As can be clearly seen in FIG. 4, the articulated device 5 comprises two rigid parts 20 and 21 connected by a joint 22, allowing these two rigid parts 20 and 21 to pass from a folded position (state shown in FIG. 4), inhibiting the user’s head from passing inside the hood 1 to an unfolded position (state shown in FIG. 5), allowing the user’s head to pass inside the hood 1.

The articulated device 5 has a mass of at least 50%, in particular at least 60% or 70%, of the total mass of the hood 1.

Thus, the articulated device 5, being quite heavy compared to the rest of the hood, allows it to act reliably to unfold the hood 1 by gravity.

The two parts 20 and 21 of the articulated device are formed by two tubular portions connected by the joint 22 to form an open ring in the unfolded position.

The articulated device 5 is configured to provide a self-contained breathing function for the user who has put on the hood 1. This is the case for hoods intended for real use, unlike training hoods which may be simpler.

Thus, the articulated device 5 comprises an oxygen reservoir 24 formed in the tubular part 21 and provided with an oxygen outlet orifice opening into the internal volume of the flexible envelope 2.

The tubular part 20 comprises a CO2 capture cartridge 25, for example of lime, configured to adsorb the CO2 from the user's breath.

In the example described, the tubular portion 21 which comprises the oxygen reservoir 24 is curved, and the tubular portion 20 which comprises the CO2 capture cartridge 25 is straight.

In the case of a training hood, which may omit the functional equipment that may be fitted to a protective hood intended for actual use, it can be fitted with an articulated device without a breathing function, but still allowing users to practice deploying the hood.

The tubular part 20 of the articulated device 5 includes, at its end 29 opposite the joint 22, a timer 30 configured to be triggered when the articulated device 5 passes from the folded position (FIG. 4) to the unfolded position (FIG. 5).

The timer 30 is fitted with a trigger member 31 configured to trigger the timer 30, this trigger member 31 being connected, on the one hand, to the timer 30 and, on the other hand, to the tubular part 21 of the articulated device 5, so that the separation between the two parts 20 and 21 of the articulated device 5 acts on the trigger member 31 to trigger the timer 30.

The trigger member 31 is removably connected to the timer 30 so that the separation of the two parts 20 and 21 of the articulated device 5 from its folded position to its unfolded position causes the trigger member 31 to be extracted from the timer 30, which results in the timer being triggered and starting a countdown.

As can be seen in FIGS. 4 and 6, the trigger member 31 includes a trigger tab 33 configured to be inserted into a slot 34 of the timer 30.

The timer 30 is configured to be in off mode as long as the tab 33 is retained in place.

For example, extracting the tab 33 allows the timer 30 to be connected to an electrical power supply source, for example, a battery.

Alternatively, the trigger tab 33 is made of electrically insulating material and is configured to maintain open an electrical power supply circuit for the timer 30.

The extraction of this trigger tab 33 causes the timer’s electrical power supply circuit to close, and the timer starts.

The timer 30 is part of an electronic board 35.

For example, the timer 30, or the electronic board 35 that defines the timer, is mounted in a cover 36 of the CO2 capture cartridge 25.

Advantageously, the timer 30 is placed away from the oxygen reservoir 24 (on the other rigid part of the articulated device) which may include metal parts that could pose a risk of electric arcs.

The trigger member 31 includes at least one wire 37 connecting the removable trigger tab 33 and the opposite part 21 of the articulated device 5.

The wire 37 is configured so that, when the articulated device 5 is moved from its folded position to its unfolded position, this wire 37 is tensioned and pulls the removable tab 33 to extract it from the slot 34 of the timer.

The removable trigger tab 33 comprises a double loop 38 for the passage of the wire 37.

This double loop 38 allows for maximum material in the extraction axis of the tab 33.

The double loop 38, made of a sufficiently flexible material of the tab 33, each with a notch inlet 39, makes it possible to easily place the wire 37 in the notch 40.

A notch 40 and a counter-notch 41 are provided to inhibit the lace from coming loose from the double loop 38.

The wire 37 is of sufficient length so that, when the hood 1 is in the folded state, this wire 37 is slack (as can be seen in FIG. 4). Thus, no tension is exerted on the trigger tab by the wire 37.

The removable trigger tab 33 comprises a non-return member 42 configured to oppose, with a predetermined force, the extraction of this tab 33 from the slot 34 of the timer.

The non-return member 42, in the form of an elastic lug, makes it possible, during assembly operations (for example, folding and insertion into the bag and vacuuming), to eliminate the risk of applying a force to the tab 33 that could unintentionally trigger the timer 30. The non-return member 42 increases the force desired to remove the tab 33 and thus inhibits unintentional triggering.

The non-return member comprises a protuberance 43 housed in the slot 34.

In the example described, the removable trigger tab 33 is made from a plate, for example, a plastic plate, in particular cut with a water jet.

The hood 1 is configured to provide the user with at least one information regarding the use of the hood based on data provided by the timer 30, this use information being a warning indicating the end of the oxygen supply available in the articulated device 5 when the timer has measured a predetermined duration, for example, a duration of 15 minutes.

The hood 1 includes an indicator light 45, formed by one or several LEDs, configured to provide the user with information regarding the use of the hood. This indicator light 45 is placed on the electronic board 35.

The indicator light 45 is controlled by the electronic board 35 to control the emission of light according to different modes.

For example, as illustrated in FIG. 8, following the triggering of the timer 30 at time T0 and after a period PS, for example, of 14 minutes, the electronic board 35 is configured to flash the indicator light 45 for a first period P1 lasting, for example, one minute. The expiration of the first period P1 corresponds to reaching the moment Tcr at which the regulatory usage time of the hood expires, which is, for example, of 15 minutes. This regulatory usage time is determined by the manufacturer based on the availability of oxygen in the supply.

Then the indicator light 45 is maintained constantly lit for a second period P2, for example, of 3 minutes, and then the electronic board 35 is configured to turn off the indicator light 45 at the expiration of the second period P2. The user must be able to absolutely remove the hood before the end of this period P2.

The present disclosure thus provides an effective warning to the user, so that they can manage the intervention time and remove the hood in time, when the oxygen supply of the hood 1 is exhausted.

Other warning sequences can of course be considered, for example using another light sequence and/or a sound sequence.

The timer 30 is configured to be triggered independently of the triggering of the oxygen supply.

We will now describe a method for packaging a protective hood 1 as described above, in a bag 50, under vacuum, the packaging method including the following: fold the hood 1 so as to leave the handle 10 visible and accessible when the hood 1 is in the folded state, place the hood 1 thus folded in the bag 50, close the bag 50.

During folding, the visor 7 is placed on the folded flexible envelope 2 (see FIG. 1) so that folds of the flexible envelope are behind the visor 7.

In one example, the visor 7 is positioned as flat as possible or with its initial curvature against the articulated device to inhibit phenomenon of cracks appearing in the material when it remains constrained by folding for a long storage period, which can be between 10 and 15 years.

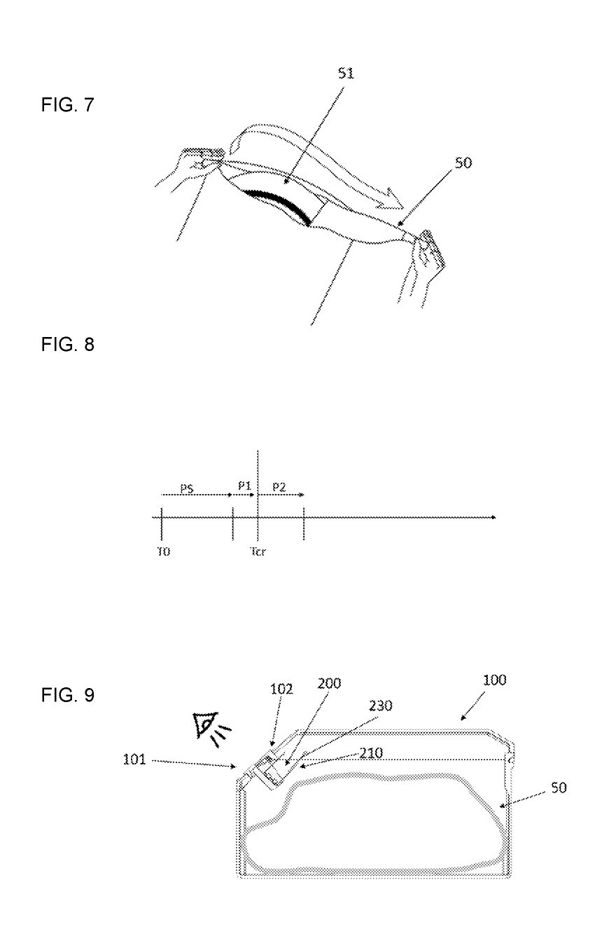

We will now describe the method for deploying a hood 1 as described above, which is initially stored under vacuum in the folded state in a bag 50, the method including the following: open the bag 50 by the user U to be able to take out the hood 1 in the folded state (see FIG. 7), lift the hood 1, initially in the folded state, using the handle 10 held by the user, in the raised position, so that the flexible envelope 2 can unfold under the action of the weight of the base of the flexible envelope 2 and the articulated device 5, to pass from the folded state to the unfolded state (see FIG. 2), when the flexible envelope 2 is in the unfolded state, turn the hood 1 over and separate the two rigid parts 20 and 21 from each other to cause the articulated device 5 to pass to the unfolded position, so that the user can put on the hood 1.

Thanks to the present disclosure, it is thus possible to deploy the hood 1 simply by holding it vertically using the handle 10, without having to abruptly shake the hood.

The timer 30 is triggered when the articulated device 5 passes from the folded position to the unfolded position during deployment.

For use in real-life situations, the hood 1 is stored in the bag 50, which is itself placed in a packaging box 100. For use on board an aircraft, the packaging box 100 is placed in a compartment accessible by the flight crew. The packaging box 100 is, for example, made of metal and is provided with an opening flap 101 which can be opened by the flight crew to be able to take out the bag 50.

We will now describe, with reference to FIGS. 9 to 13, an operability indicator device 200 configured to be fitted to such a packaging box 100.

The operability indicator device 200 is placed in an opening 102 on the opening flap 101 of the packaging box 100.

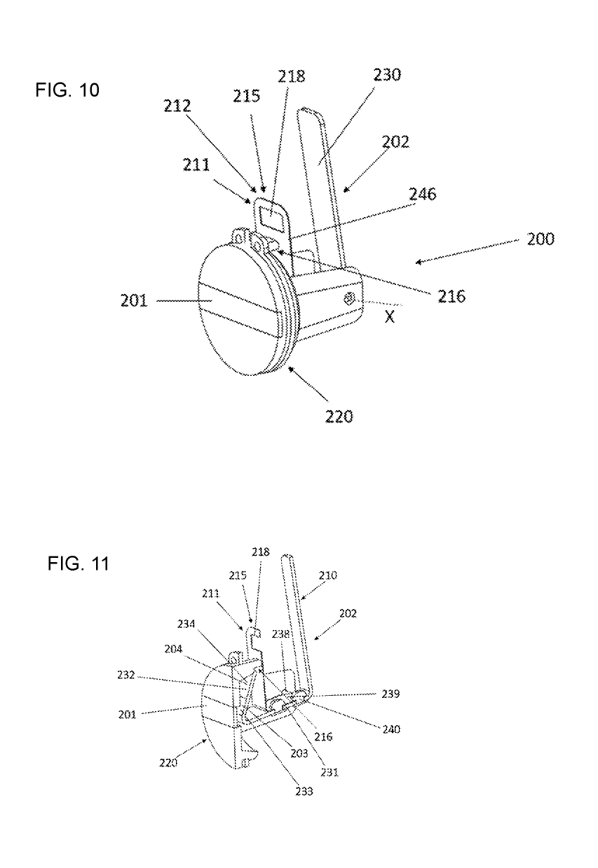

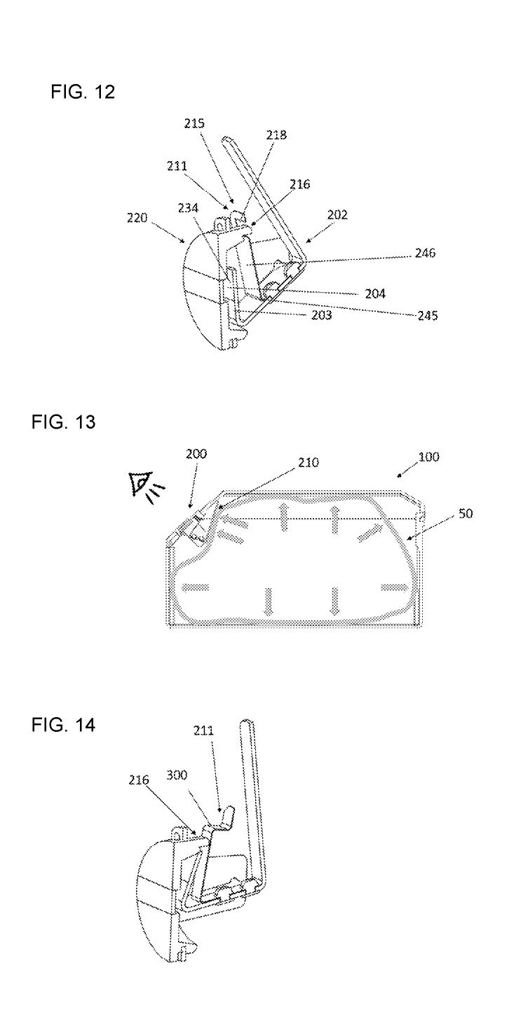

As shown in FIGS. 10 to 12, the operability indicator device 200 includes a viewing window 201, and a flag member 202 including a visual indicator of proper operation 203 and a visual indicator of malfunction 204, this flag member 202 being movable between a nominal position (see FIG. 11) in which the visual indicator of proper operation 203 is visible through the viewing window, and a warning position (see FIG. 12) in which the visual indicator of malfunction 204 becomes visible through the viewing window 201, replacing the visual indicator of proper operation 203.

The flag member 202 further comprises a bearing face 210 against which the bag 50 bears upon the inflation of this bag 50 inside the packaging box 100, this bearing on the bearing face 210 causing the flag member 202 to move from the nominal position towards the warning position, as illustrated in FIG. 13.

The operability indicator device 200 further comprises a spring 211 secured to the flag member 202 and configured to exert an elastic restoring force opposing the passage of the flag member 202 from the nominal position towards the warning position until sufficient force is exerted by the inflating bag 50 on the bearing face 210 of the flag member 202, causing the flag member 202 to pass from the nominal position to the warning position.

The operability indicator device 200 further comprises an element 212 for retaining the flag member 202 in the warning position once this warning position has been reached, so that the flag member 202 remains in the warning position even if the force exerted on the bearing face 210 of the flag member 202 ceases or is reduced.

First, the present disclosure makes it possible to visually verify whether the bag 50, for various reasons, has inflated abnormally, in particular until this bag 50 perforates. Such inflation followed by perforation of the bag 50 results in the equipment contained therein being rendered inoperative. The present disclosure thus makes it possible to reliably verify whether the safety equipment, in particular the protective hood, is operative or not. For example, the flight crew must be able to verify, using the operability indicator device according to the present disclosure, whether the equipment is still maintained under vacuum in the bag 50. Thanks to the present disclosure, it is possible to view the operability indicator device 200 placed on the packaging box. This operability indicator device 200 makes visible through the viewing window 201 either a visual indicator of proper operation 203 or a visual indicator of malfunction 204.

If the bag inflates 50, it exerts a thrust on the flag member 202. If the thrust reaches a certain threshold, then the flag tilts into the warning position and the visual indicator of malfunction 204 appears through the viewing window 201. The present disclosure is particularly advantageous in that, after the pressure of the bag 50 on the flag member 202 is released, this flag member 202 is retained in the warning position thanks to the retaining element 212 according to the present disclosure. The operability indicator device 200 according to the present disclosure thus makes it possible to memorize a situation of excessive inflation followed by perforation of the bag 50, so that the user is informed that the equipment is inoperative and should not be used. This warning is maintained even if the pressure of the bag 50 on the flag member 202 is released or has disappeared. In the absence of such a retaining element 212 according to the present disclosure, the flag member 202 would return to its nominal position under the action of the spring 211, which would erase the information about an anomaly in the inflation of the bag 50.

The retaining element 212 is part of the spring 211.

The retaining element 212 is formed by a locking portion 215 of the spring 211 configured to engage with a locking element 216 on a flag holder 220 of the operability indicator device. This flag holder 220 is made of plastic material and is configured to be fastened to the box by clipping or other means. The viewing window 201 is formed on a front face of this flag holder 220.

The locking portion 215 of the spring 211 is formed by a locking window 218 configured to engage on the locking element 216 on the flag holder 220.

This locking element 216 on the flag holder 220 is formed by a protrusion or boss on the flag holder 220.

The locking window 218 on the spring 211 is substantially rectangular.

Thus, when the flag member 202 reaches the warning position, the spring 211 has the locking window 218 engaged on the locking boss of the flag holder 220 so that, even when the pressure exerted on the flag member 202 ceases, the interaction between the locking window 218 of the spring 211 and the locking boss on the flag holder 220 inhibits the flag member 202 from returning towards the nominal position.

The flag member 202 is configured to pivot about an axis of rotation X passing through the flag holder 220.

The flag member 202 includes a bearing tab 230 that defines a bearing face 210 against which the bag 50 bears upon the inflation of the bag 50.

The flag member 202 includes a central portion 231 fastened with the spring 211.

This fastening is achieved using one or several rivets that retain the flag member 202 and the spring 211 together.

The flag member 202 includes an information tab 232 including a first area 233 corresponding to the visual indicator of proper operation 203 and a second area 234 corresponding to the visual indicator of malfunction 204.

These first and second areas 233 and 234, adjacent to each other, are formed on a flat face of the information tab 232 and have different colors. These colors are chosen to allow the user to easily recognize proper operation or malfunction. For example, these colored areas are painted areas.

The first area 233 corresponding to the visual indicator of proper operation 203 is green, and the second area 234 corresponding to the visual indicator of malfunction 204 is red.

Other visual information, different from or in addition to colors, may be used. For example, a drawing or letters may be used as flags.

The flag member 202 has a substantially U-shaped side profile, with the central portion 231 and, at the ends of this central portion, the bearing tab 230 and the information tab 232.

The bearing tab 230 has a greater length than the information tab 232.

When the flag member 202 tilts about the axis of rotation X, the information tab 232 pivots so that, in the nominal position, the first area 233 corresponding to the visual indicator of proper operation 203 is visible through the viewing window 201. When the flag member 202 has tilted into the warning position, the second area 234 of the information tab 232 of the flag member 202 becomes visible in the viewing window 201.

The flag member 202 is made of a rigid material and may be made of metal or, alternatively, of plastic material, in particular polycarbonate.

The central portion 231 of the flag member 202 has two lateral pins 238 serving as joints for pivoting about the axis of rotation X.

The spring 211 includes a stage 239 for fastening the spring 211 to the flag member 202.

The rivets 240 pass through this fastening stage 239.

The spring 211 includes a bend 245 between a portion of the spring 211 forming a leaf 246 and this fastening stage 239.

The bend 245 forms an angle of approximately 90°, namely a right angle, when the spring 211 and the flag member 202 are in the nominal position.

The leaf 246 of the spring 211 includes the locking window 218.

The locking window 218 is formed at one end of the leaf 246 opposite the bend 245 that connects the leaf 246 to the fastening stage 239.

The locking window 218 on the leaf is formed above the contact point between the leaf 246 and the locking relief 216 on the flag holder 220 so that when the flag member 202 tilts from the nominal position, a solid part of the leaf 246 bears against the locking relief 216 of the flag holder 220.

Thus, the spring 211 folds around the bend 245 due to the force exerted by the tilting flag member 202. The spring 211 then bears, with its leaf 246, against the locking relief or boss 216 of the flag holder 220 until the warning position is reached. When the tilt reaches the warning position, the window 218 engages in the locking relief or boss 216 of the flag holder 220, and this retention inhibits the spring 211 from returning the flag member 202 towards the nominal position.

The spring 211 has a width of between 8 and 14 mm, in particular 12 mm.

The flag holder 220 of the operability indicator device 200 comprises the viewing window 201 provided with a transparent plate placed in front of the information tab 232 of the flag member 202.

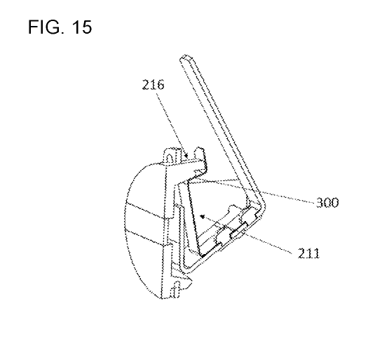

In a variant illustrated in FIGS. 14 and 15, the locking window 218 on the spring 211 can be replaced by a step 300 formed on the leaf 246 of the spring, the step 300 being configured to engage under the locking relief or boss 216 of the flag holder 220, so as to lock the spring leaf under this relief or boss 216 of the flag holder 220. In this case, the spring leaf 246 can be solid, without a locking window 218.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random

access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An operability indicator device configured to be fitted to a packaging box in which a bag containing, under vacuum, a protective hood is placed, the operability indicator device comprising:
a viewing window;
a flag member including a first visual indicator of proper operation and a second visual indicator, the flag member configured to move between a nominal position in which the first visual indicator of proper operation is visible through the viewing window, and a warning position in which the second visual indicator is visible through the viewing window to replace the first visual indicator of proper operation, the flag member including a bearing face against which the bag is configured to bear upon an inflation of the bag inside the packaging box to move the flag member from the nominal position towards the warning position;
a spring secured to the flag member, the spring configured to exert an elastic restoring force opposing a movement of the flag member from the nominal position towards the warning position until a force threshold is reached by the inflating bag on the bearing face of the flag member which is configured to cause the flag member to pass from the nominal position to the warning position, and
a retainer element configured to retain the flag member in the warning position when the warning position has been reached by the flag member, so that the flag member remains in the warning position even if a force exerted on the bearing face of the flag member is reduced.

2. The operability indicator device according to claim 1, wherein the retainer is formed by a locking portion of the spring, and the locking portion is configured to engage with a locking element on a flag holder coupled to the packaging box.

3. The operability indicator device according to claim 2, wherein the locking portion of the spring is formed by a locking window, and the locking window is configured to engage on the locking element on the flag holder.

4. The operability indicator device according to claim 2, wherein the spring includes a bend between a portion of the spring forming a leaf and a fastening stage.

5. The operability indicator device according to claim 4, wherein a locking window on the leaf is formed above a contact point between the leaf and the locking element on the flag holder, and a solid part of the leaf is configured to bear against the locking element of the flag holder when the flag member tilts from the nominal position.

6. The operability indicator device according to claim 2, wherein the flag holder includes the viewing window, and the viewing window includes a transparent plate placed in front of an information tab of the flag member.

7. The operability indicator device according to claim 1, wherein the flag member includes an information tab including a first area corresponding to the first visual indicator of proper operation and a second area corresponding to the second visual indicator.

8. The operability indicator device according to claim 7, wherein the first area and the second area have different colors, the first area corresponding to the first visual indicator of proper operation is green, and the second area corresponding to the second visual indicator is red.

9. The operability indicator device according to claim 7, wherein the flag member has a U-shaped side profile, with a central portion, a bearing tab is at a first end of the central portion and the information tab is at a second end of the central portion.

10. The operability indicator device according to claim 1, wherein the spring has a width of between 8 and 14 mm.

11. A packaging box for a protective hood including an operability indicator device according to claim 1.
